(19) United States
(12) Patent Application Publication
(10) Pub. No.: US 2025/0091045 A1
(43) Pub. Date: Mar. 20, 2025

(54) Illumination Apparatus for Illuminating a Microfluidic Device, Analyzer having an Illumination Apparatus, and Method for Illuminating a Microfluidic Device

(71) Applicant: Robert Bosch GmbH, Stuttgart (DE)

(72) Inventors: Reinhold Fiess, Durbach (DE); Ingo Ramsteiner, Ettlingen (DE)

(21) Appl. No.: 18/727,570

(22) PCT Filed: Jan. 13, 2023
(86) PCT No.: PCT/EP2023/050728

§ 371 Date: Jul. 9, 2024

(30) Foreign Application Priority Data
Jan. 18, 2022 (DE) 10 2022 200 502.3

(51) Int. Cl. B01L 3/00; G01N 21/88

(52) U.S. Cl. CPC B01L 3/502715; G01N 21/8806; B01L 2300/0654; B01L 2300/168; G01N 2201/06193; G01N 2201/068

(57) ABSTRACT

An illuminating apparatus for illuminating a microfluidic device disposed in a receiving region of an analyzer is disclosed. The illumination apparatus includes (i) at least one fluorescent light source designed to output a fluorescent light beam when excited by excitation radiation by fluorescing, (ii) a focusing device for focusing the fluorescent light beam, wherein the focusing device is designed to convert the fluorescent light beam into a focusing light beam, and (iii) a mirror mechanism for directing the focusing light beam towards the microfluidic device, wherein the mirror mechanism includes at least one movable mirror element.

### PRIOR ART

The invention proceeds from an illumination apparatus, an analyzer having an illumination apparatus, and a method for illuminating according to the genus of the independent claims.

To analyze sample material, what are referred to as lab-on-chip cartridges comprising a sample can be inserted into analyzers and processed. For example, a molecular diagnostic assay can be disposed on a plastic cartridge comprising a microfluidic network. The analyzer can be designed to process such cartridges, i.e., it can control microfluidic processes on the cartridge and, e.g., heat or illuminate certain regions.

### DISCLOSURE OF THE INVENTION

In light of this, with the approach presented herein, an illumination apparatus, an analyzer with an illumination apparatus, and a method of illuminating according to the main claims are presented. Advantageous embodiments of and improvements to the apparatus specified in the independent claim are made possible by the measures presented in the dependent claims.

With the illumination apparatus presented herein, it is advantageously possible to illuminate one or more contiguous surfaces, for example on a lab-on-chip cartridge, with light. The number, shape, and size of the surfaces can be freely selected within a certain range and can be flexibly controlled electronically. The light itself may advantageously meet the requirements for fluorescence excitation of molecular diagnostic assays, also with multiple color channels. This means a spectrum that is precisely defined in terms of center wavelength and width, or a plurality of such spectra, between which switching is possible.

An illuminating apparatus for illuminating a microfluidic device disposed in a receiving region of an analyzer is presented. The illumination apparatus comprises at least one fluorescent light source, designed to output a fluorescent light beam when excited by excitation radiation by fluorescing, and a focusing device for focusing the fluorescent light beam, wherein the focusing device is designed to convert the fluorescent light beam into a focusing light beam. In addition, the illumination apparatus comprises a mirror means for directing the focusing light beam towards the microfluidic device, wherein the mirror means comprises at least one movable, in particular mechanically moveable, mirror element.

For example, the analyzer can be a device for performing diagnostic tests, such as rapid PCR tests. For example, a sample, which can be a liquid comprising sample material or a solid sample, can be introduced into a suitable microfluidic device, which can be a lab-on-chip cartridge comprising a microfluidic network for processing the sample. The microfluidic device with the sample can, e.g., be manually introduced into the analyzer's receiving region to be processed within the analyzer. The analyzer can in this case comprise the illumination apparatus described herein, which can also be referred to as an excitation optic, in order to excite the sample by means of illumination. The illumination apparatus presented herein can advantageously be used to illuminate one or more surfaces on a lab-on-chip cartridge. A light source may also be understood to mean a channel. The number, shape and extent of the surfaces to be illuminated may additionally or alternatively be flexibly electronically controllable. The light used to illuminate may meet the requirements for fluorescence excitation of molecular diagnostic assays. Many molecular diagnostic methods, such as polymerase chain reactions (PCR), are based on fluorescence measurements from a metrological point of view. The indirect generation of light by means of fluorescent or phosphorescent materials may be necessary. This may advantageously be made possible with the illumination apparatus presented herein, for example by using a fluorescent light source instead of one or more laser diodes. The fluorescent light source may also be called a phosphor-based light source. The established term “phosphor” in this context does not refer to the element of the same name, but generally to a suitable luminescent material, which can be excited to emit fluorescent light, for example by a primary light source such as a laser diode. Advantageously, extremely small light sources may be realized with such sources, so that the fluorescent light generated in this way can then also be easily collimated or focused, for example on or via a (micro-) mirror in the sense of the invention. For the aforementioned focusing on the mirror means, the focusing device of the illumination apparatus may comprise, for example, lenses, concave mirrors or similar optical elements. The illumination distribution itself can be controlled by means of an, in particular mechanically controllable, mirror element, for example a micromechanical mirror. The illumination may take place according to the so-called flying spot principle, for example, wherein the beam is scanned or guided over the respective surfaces using the mirror.

According to one embodiment, the focusing device may comprise at least one holographic optical element. For example, the fluorescent light beam may be directed to the mirror element via a holographic optical element (HOE). This offers the advantage of being able to select a wavelength via the HOE, which could alternatively be done elsewhere, for example using dielectric interference filters in the beam path. In addition, this embodiment offers the particular advantage that it can use the available light very efficiently. Other projector methods, such as based on LCD, DLP, SLM, LCOS, are based on micromechanical or liquid crystal based modulators that generate intensity distribution via subtraction, i.e., light available is discarded to darken particular regions. Holograms, on the other hand, can advantageously be used to realize intrinsically wavelength-selective beam-guiding elements. Such an HOE may, for example, have a multiplex hologram or multiple single holograms layered on top of each other. The individual holograms may be set up, for example, such that they can deflect a spherical wave with the desired wavelength from the fluorescent light source onto the mirror in a focused manner. Depending on which phosphor, or which fluorescent material, is currently being excited and emitted, the mirror element can then be illuminated at the desired wavelengths.

According to a further embodiment, the mirror means may comprise at least one micromechanical mirror. For example, as a movable mirror element, a micromechanical mirror is preferred. For example, the illumination may take place according to the so-called flying spot principle, for example, wherein the beam is scanned or guided over the respective surfaces using the mirror. Depending on the application-side requirements, a progressive scanning method may be used, i.e., line by line, or a Lissajous scanner. The latter has the advantage that larger deflection angles with a larger mirror surface area are possible. Accordingly, such a mirror means can therefore advantageously be optimized to meet the requirements and can also be implemented cost-effectively.

According to a further embodiment, the fluorescent light source may be designed to output the fluorescent light beam in a narrow band. A narrow band is preferably a spectral half-width of less than 100 nanometers (nm), preferably less than 50 nm, more preferably less than 30 nm, for example 40 or 20 nm. For example, particularly narrow-band phosphors may be used as light source, for example SrGa2S4: Eu2+ (emission at 540 nm, FWHM approximately 45 nm) or Ba0.8Sr0.2Mg3SiN4: Eu (emission at 635 nm, FWHM approximately 45 nm). This is particularly advantageous if the respective phosphor is used only for one excitation channel and is changed for other channels. Besides the phosphor materials known from the prior art, semiconductor quantum points may also be employed.

According to a further embodiment, the fluorescent light source may be designed to output the fluorescent light beam with at least one wide wavelength band. Broadband phosphors such as Y3Al3O12: Ce (having a half-width of 120 nm) or mixtures with multiple narrow-band emitters, for example 2 to 4 or more luminescent materials each having a half-width of 40-80 nm, may be particularly advantageous if the phosphor is used for multiple excitation channels and the switching is via a wavelength-selecting optics (filter).

According to a further embodiment, at least one optical bandpass filter may be disposed in the beam path of the fluorescent light beam. The focusing optics have the task of collecting the fluorescent light of the phosphor radiated at a large spatial angle and focusing it onto the mirror. Conventional components such as refractive or diffractive lenses or concave mirrors can be used in this case, for example. If such a solution is selected, a wavelength-selective device, preferably a bandpass filter, may be required as part of this optic depending on the bandwidth of the fluorescent light. This has the advantage that undesired spectral portions of the light can be removed by means of the bandpass filter.

In addition, the bandpass filter may be interchangeably disposed by a bandpass filter having a further bandpass characteristic. For example, the emission spectrum of the phosphor may comprise a broad band with a preferred half-value width of greater than 100 nm, more preferably greater than 150 nm, or a plurality of narrower bands, wherein all desired excitation wavelengths are contained therein. In this case, the bandpass filter may be one of several that may be replaced, for example by means of a mechanical exchange unit, such as a filter wheel or slider. According to one particular embodiment, the lighting device thus comprises at least two interchangeable bandpass filters. Depending on the desired excitation channel, the respective filter can then advantageously be placed in the beam path and thus the required spectral band can be directed via the mirror.

According to a further embodiment, the fluorescent light source may be disposed interchangeably by a light source having a different fluorescence characteristic. For example, the fluorescent light source may be replaced by another fluorescent light source, as well as optionally by further light sources with emission characteristics different from the first emission characteristic, for example. According to one particular embodiment, the lighting device thus comprises at least two interchangeable light sources. For example, the light sources may be disposed next to each other on an interchangeable element or carrier. For example, the illumination apparatus may be designed to move the carrier with the lighting means such that the desired lighting means is in the focus of the excitation light. Advantageously, a specific fluorescent light source may thereby only be utilized for one excitation channel and may be switched for other channels.

According to a further embodiment, the illumination apparatus may comprise a further fluorescent light source, which may be designed to output a further fluorescent light beam when excited by the excitation radiation or a further excitation radiation by fluorescing. For example, the illumination apparatus may comprise a plurality of fluorescent light sources, which, for example, can in particular be mechanically changed and additionally or alternatively controlled by means of a control device. For example, some of these light sources may be phosphor based, and others may be designed as laser diodes, for example. Separate light sources can be combined, for example via a mirror element. If the individual phosphor bands are narrow enough not only to emit light in any of the channels not associated with them, a fixed focusing optic, for example with a fixed multiband pass filter, can advantageously be employed in this embodiment.

For example, the illumination apparatus may comprise at least three further fluorescent light sources, which may be designed to output further fluorescent light beams when excited by the excitation radiation or at least a further excitation radiation by fluorescing. Thus, for example, the illumination apparatus may comprise a total of four, five or more light sources.

According to a further embodiment, the illumination apparatus may comprise a primary light source, which may be designed to output the excitation radiation to excite the fluorescent light source. For example, the illumination apparatus may comprise at least one primary light source and a phosphor material. For example, laser diodes or laser diode arrays are suitable as a primary light source. Arrangements with a plurality of fluorescent light sources in which each fluorescent light source has its own primary source may be possible, as well as, for example, a primary light source capable of providing excitation light to a plurality of fluorescent light sources. Advantageously, the illumination process can be optimized by the use of a primary light source which can be selected according to the requirements.

According to a further embodiment, the illumination apparatus may comprise a control means, which can be designed to provide a directing signal for directing the focusing light beam to the mirror means and, additionally or alternatively, to provide an action signal for switching the light source on and off.

For this purpose, the control device can comprise at least one computing unit for processing signals or data, at least one memory unit for storing signals or data, at least one interface to a sensor or an actuator for reading in sensor signals from the sensor or for emitting data or control signals to the actuator, and/or at least one communication interface for reading in or emitting data embedded in a communication protocol. The computing unit may, for example, be a signal processor, a microcontroller or the like, wherein the memory unit may be a flash memory, an EEPROM, or a magnetic memory unit. The communication interface can be designed to read in or emit data in a wireless and/or wired manner, wherein a communication interface capable of reading in or emitting wired data can read in said data from a corresponding data transmission line, for example electrically or optically, or emit said data to a corresponding data transmission line.

In this context, the term “control device” can be understood to mean an electrical device that processes sensor signals and emits control signals and/or data signals as a function thereof. The control device can comprise an interface, which can be designed as hardware and/or software. For example, given a hardware design, the interfaces can be part of what is referred to as an ASIC system, which contains a wide variety of functions for the control device. However, it is also possible that the interfaces are dedicated integrated circuits or consist at least partly of discrete components. When implemented as software, the interfaces can be software modules present, for example, on a microcontroller alongside other software modules.

Also presented is an analyzer for analyzing a sample in a microfluidic device, the analyzer comprising a receiving region for receiving the microfluidic device and a variant of the illumination apparatus presented hereinabove. For example, the analyzer may be designed for the integration of a molecular diagnostic assay on a plastic cartridge with a microfluidic network. The actual device may be designed to process such cartridges, i.e., it can, for example, control microfluidic processes on the cartridge and heat and, additionally or alternatively, illuminate certain regions. For example, the analyzer may include a camera with replaceable bandpass filters that may view a particular region of the cartridge. Advantageously, these regions can be illuminated with the illumination apparatus, for example with light of a defined wavelength range, in order to excite fluorescence there, which can be evaluated diagnostically.

In addition, a method for illuminating a microfluidic device disposed in a receiving region of an analyzer is presented, wherein the method comprises a step of outputting a fluorescent light beam in response to an excitation beam and a step of converting the fluorescent light beam into a focusing light beam. In addition, the method comprises a step of directing the focusing light beam towards the microfluidic device.

For example, this method can be implemented in software or hardware, or in a mixed form of software and hardware, for example in a controller.

Exemplary embodiments of the approach presented herein are shown in the drawings and explained in greater detail in the following description. The figures show:

FIG. 1 a schematic representation of an exemplary embodiment of an analyzer;

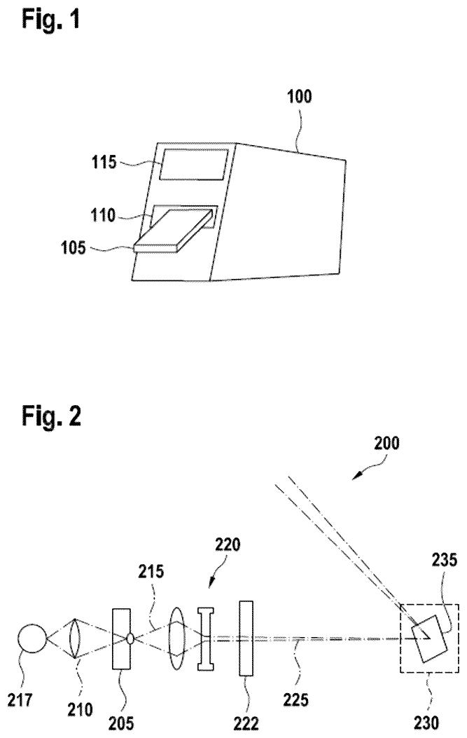

FIG. 2 a schematic representation of an illumination apparatus according to an exemplary embodiment;

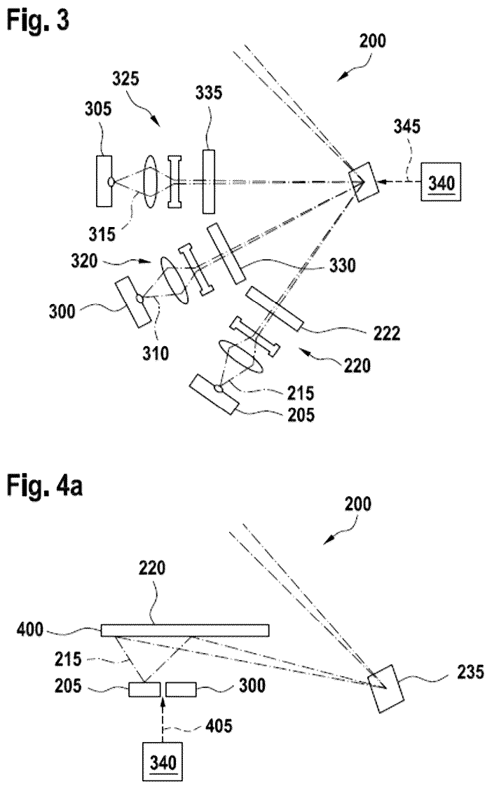

FIG. 3 a schematic representation of an illumination apparatus according to an exemplary embodiment;

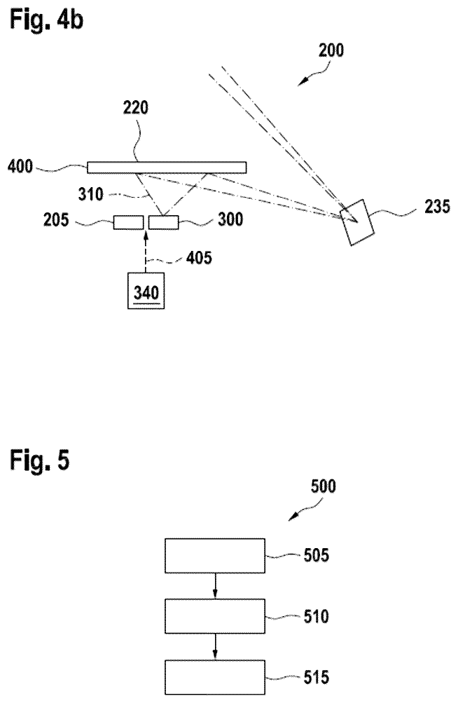

FIG. 4a a schematic representation of an illumination apparatus according to an exemplary embodiment;

FIG. 4b a schematic representation of an illumination apparatus according to an exemplary embodiment; and

FIG. 5 a flow diagram of a method for illuminating a microfluidic device disposed in a receiving region of an analyzer according to an exemplary embodiment.

In the following description of advantageous exemplary embodiments of the present invention, identical or similar reference signs are used for elements shown in the various drawings which having a similar function, so a repeated description of these elements has been omitted.

FIG. 1 shows a schematic representation of an exemplary embodiment of an analyzer 100. In this exemplary embodiment, the analyzer 100 is designed to analyze samples that have been introduced, as a result of which it is, e.g., possible perform PCR tests. For this purpose, a microfluidic device 105, which is merely an example of a cartridge with a plastic housing and a microfluidic network for processing the sample, can be inserted into a receiving region 110. In this exemplary embodiment, the analyzer further comprises a display 115 with a touch function, by means of which settings for the desired analysis process can be entered manually (by way of example only). The display 115 is, by way of example only, also designed to display analysis results.

In other words, the concept of the analyzer provides for the integration of a molecular diagnostic assay on a plastic cartridge with a microfluidic network. The actual device is designed to process such cartridges, i.e., it can control microfluidic processes on the cartridge and heat and additionally or alternatively illuminate certain regions. In particular, in this exemplary embodiment it comprises an illumination apparatus, as described in more detail in Figures through 2 and 4 below, which can excite and evaluate fluorescence signals. By way of example, this unit consists of two parts. Firstly, a camera with interchangeable bandpass filters that views a specific region of the cartridge. Secondly, a device that is designed to illuminate certain regions of the cartridge with light of a defined wavelength range in order to excite fluorescence there. These regions are disposed in the camera's field of view.

FIG. 2 shows a schematic representation of an illumination apparatus 200 according to an exemplary embodiment. The illumination apparatus 200 is designed to illuminate a microfluidic device in a receiving region of an analyzer as described in the foregoing figure. For this purpose, the illumination apparatus 200 in this embodiment comprises a fluorescent light source 205, which may also be referred to as a phosphor-based light source or a light source having a phosphorus, and which is designed to output a fluorescent light beam 215 when excited by an excitation beam 210 by fluorescing. In this exemplary embodiment, the excitation radiation 210 can be output by a primary light source 217. By way of example only, the fluorescent light source 205 comprises a particularly narrow-band phosphor, exemplified by SrGa2S4:Eu2+, and in this embodiment, designed to output the fluorescent light beam 215 in a narrow band with an exemplary emission at 540 nm and FWHM at approximately 45 nm. Accordingly, in this exemplary embodiment, the light source can only be used for one excitation channel and is interchangeably disposed for other channels by another light source, wherein the two light sources differ in their fluorescence characteristic. In another exemplary embodiment, for example Ba0.8Sr0.2Mg3SiN4:Eu (emission at 635 nm, FWHM at approx. 45 nm) can also be used. For example, in the mounted state, the illumination apparatus device 200 is disposed in the analyzer such that the respective light source can be easily replaced by a user without tools.

The illumination apparatus 200 further comprises a focusing device 220 for focusing the fluorescent light beam 215, wherein the focusing device 220, which may also be referred to as the focusing optics, comprises only an exemplary plurality of lenses, and in this embodiment, a bandpass filter 222. In the exemplary embodiment shown herein, a bandpass filter is required to remove undesirable spectral portions of the fluorescent light beam 215. In this embodiment, since the fluorescent light source 205 is one of several that are mechanically interchangeable, and in this embodiment, emits light in a narrow phosphor band in an associated channel, a fixed multiband pass filter 222 can be used in this embodiment.

By means of the focusing device 220, the fluorescent light beam 215 can be converted into a focusing light beam 225. This focusing light beam 225 can further be directed by a mirror means 230, wherein the mirror means 230 in this embodiment comprises a mechanically movable mirror element 235. By way of example only, in this embodiment, the mirror element 235 is designed as a micromechanical mirror. By means of the mirror means 230, the fluorescent light beam can be directed, by way of example, onto a microfluidic device as described in the previous figure in order to illuminate a sample disposed in the device.

In other words, the illumination apparatus 200 shown herein is divided into a phosphor-based light source, focusing optics, and a mechanically movable mirror. The phosphor-based light source comprises, by way of example, a primary light source 217 and a phosphor material excitable by an excitation radiation 210 emitted by the primary light source 217. For example, laser diodes or laser diode arrays are suitable as a primary light source. The focusing optics have the task of collecting the fluorescent light of the phosphor radiated at a large spatial angle and focusing it onto the mirror. According to the prior art, a number of conventional components such as refractive or diffractive lenses or concave mirrors can be used here. By selecting such a solution, a wavelength-selective device is required as part of this optics, which in the exemplary embodiment shown here comprises a bandpass filter in order to remove undesirable spectral portions of the light. A micromechanical mirror is preferred as a movable mirror. As a result, a flying spot projector, i.e., a light beam controllable with a moving mirror, can be used to excite a sample. Such projectors require easily focusable light sources with a small etendue, in particular with small, fast mirrors. In other exemplary embodiments, a combination of two single-axis mirrors may also be employed. Depending on the application-side requirements, a progressive scanning method, that is, line by line, or a Lissajous scanner can be employed using the illumination apparatus 200.

For example, in an exemplary embodiment, the focusing device for focusing the fluorescent light beam may comprise a bandpass filter disposed interchangeably by a bandpass filter having a further bandpass characteristic. In other words, the emission spectra of the phosphor based light source may have a wide band, or multiple narrower bands, wherein all desired excitation wavelengths are included therein. The bandpass filter may be one of several that may be interchanged, for example by means of a mechanical exchange unit, such as a filter wheel or slider. Depending on the desired excitation channel, the respective filter can be inserted into the beam path and thus direct the respective required spectral band via the mirror means.

FIG. 3 shows a schematic representation of an illumination apparatus 200 according to an exemplary embodiment. The illumination apparatus 200 shown here corresponds to or resembles the illumination apparatus described in the previous FIG. 2, with the difference that in this embodiment, the illumination apparatus 200 comprises a plurality of channels, here in addition to the fluorescent light source 205 a further fluorescent light source 300 and an additional fluorescent light source 305 whose light beams are combinable via a mirror. The further fluorescent light source 300 is designed in an exemplary embodiment to output a further fluorescent light beam 310 when excited by the excitation radiation described in the previous FIG. 2 or by a further excitation radiation by fluorescing. Likewise, in an exemplary embodiment, the additional fluorescent light source 303 is designed to output a further fluorescent light beam 315 excited by the excitation radiation or by an additional excitation radiation by fluorescing. Here, the fluorescent light source 205, the further fluorescent light source 300 and additional fluorescent light source 305 are only exemplary designed to output fluorescent light beam 215, the further fluorescent light beam 310 and the additional fluorescent light beam 315 with a narrow wavelength band each, by way of example only. Consequently, in this embodiment, beams emitted by different light sources 205, 300, 305 equipped with different phosphors hit the mirror means from different directions.

According to an exemplary embodiment, the illumination apparatus comprises, in addition to the three fluorescent light sources 205, 300, 305 shown, at least one further fluorescent light source, i.e., a total of four or five or more than five fluorescent light sources 205, 300, 305, the light beams of which can be combined via a common mirror. The different light sources 205, 300, 305 are used according to an exemplary embodiment to emit light beams of different characteristics, for example different wavelengths.

In this embodiment, the illumination apparatus 200 also comprises, by way of example only, a control device 340 which is designed to provide, by way of example only, a directing signal 345 for directing the focusing light beam to the mirror means 230. Accordingly, illumination of one or more surfaces, for example on a lab-on-chip cartridge, is enabled with light. The number, shape, and size of the surfaces can be freely selected within a certain range and can be flexibly controlled electronically. The light itself meets the requirements for the fluorescence excitation of molecular diagnostic assays, for example also with multiple color channels. This means a spectrum that is precisely defined in terms of center wavelength and width, or a plurality of such spectra, between which switching is possible.

For example, in other embodiments, not all of the light sources may be phosphor based, for example using different optics. This concept is known from RGB projectors. For example, it is also contemplated that one or more of the sources are laser diodes. In addition, other tunable filters may be employed instead of the bandpass filters.

FIGS. 4a and 4b each show a schematic representation of an illumination apparatus 200 according to an exemplary embodiment. The illumination apparatus 200 shown here corresponds to or resembles the illumination apparatus described in the preceding FIGS. 2 and 3, with the difference that the focusing device 220 in this exemplary embodiment comprises a holographic optical element 400. An intrinsic wavelength-selective beam-guiding element is thus realized by way of example only. In this embodiment, the illumination apparatus 200 comprises the fluorescent light source 205, the further fluorescent light source 300, and a focusing device 220 having the holographic optical element 400 (HOE), which in this embodiment focuses light, i.e., the fluorescent light beam 215 or the further fluorescent light beam 310, from the two light sources 205, 300 onto the mirror element 235. By way of example only, in this embodiment, the holographic optical element 400 comprises multiple single holograms layered on top of each other. In this exemplary embodiment, the individual holograms are set up such that they each deflect a spherical wave with the desired wavelength from a phosphor onto the mirror in a focused manner. In this embodiment, the control device 340 is designed to switch the desired light source 205, 300 on and off using an action signal 405. Depending on which phosphor is currently being excited and emitting, the mirror element 235 is then illuminated at the desired wavelengths.

In other words, the core of the illumination apparatus 200 shown here is to control the illumination distribution by means of a mechanically controllable mirror, for example a micromechanical mirror. The illumination takes place according to the flying spot principle, for example, wherein the beam is scanned or guided over the respective surfaces using the mirror. Instead of one or more laser diodes, phosphor-based light sources 205, 300 are used. The established term “phosphor” in this context does not refer to the element of the same name, but generally to a suitable luminescent material, which can be excited to emit fluorescent light by a primary light source such as a laser diode. With such sources, extremely small light sources can be realized so that the fluorescent light generated in this way can in turn also be easily collimated or focused. In this exemplary embodiment, the fluorescent light of the phosphor can thereby be directed towards the mirror via a holographic optical element 400 (HOE).

In another exemplary embodiment, the HOE may also be designed as a multiplex hologram, and the focusing on an exemplary micromirror may be, for example, according to the prior art with lenses, concave mirrors, or similar optical elements. Furthermore, optional arrangements are contemplated in which each phosphor has its own primary source. In addition, the dual channel embodiment shown may also be extended to three, four or more channels. The advantage of this arrangement is that a single, potentially cost-effective element, the HOE, combines multiple functions, allows beam guidance and wavelength filtering, and channel changes without moving parts.

FIG. 5 shows a flow diagram of a method 500 for illuminating a microfluidic device disposed in a receiving region of an analyzer according to an exemplary embodiment. The method 500 comprises a step 505 of outputting a fluorescent light beam in response to an excitation beam. Furthermore, the method 500 comprises a step 510 of converting the fluorescent light beam into a focused focusing light beam and a step 515 of directing the focusing light beam towards the microfluidic device.

1. An illumination apparatus for illuminating a microfluidic device disposed in a receiving region of an analyzer, the illumination apparatus comprising:
at least one fluorescent light source designed to output a fluorescent light beam when excited by excitation radiation by fluorescing;
a focusing device configured to focus the fluorescent light beam, wherein the focusing device is designed to convert the fluorescent light beam into a focusing light beam; and
a mirror mechanism configured to direct the focusing light beam towards the microfluidic device, wherein the mirror mechanism means comprises at least one movable mirror element.

2. The illumination apparatus according to claim 1, wherein the focusing device comprises at least one holographic optical element.

3. The illumination apparatus according to claim 1, wherein the mirror mechanism comprises at least one micromechanical mirror.

4. The illumination apparatus according to claim 1, wherein the fluorescent light source is designed to output the fluorescent light beam in a narrow band with a spectral half-width less than 100 nm.

5. The illumination apparatus according to claim 1, wherein the fluorescent light source is designed to output the fluorescent light beam having at least one wide wavelength band, in particular having a spectral half-width greater than 100 nm.

6. The illumination apparatus according to claim 1, wherein at least one optical bandpass filter is disposed in the beam path of the fluorescent light beam.

7. The illumination apparatus according to claim 6, wherein the bandpass filter is disposed interchangeably with a bandpass filter having a further bandpass characteristic.

8. The illumination apparatus according to claim 1, wherein the fluorescent light source is disposed interchangeably with a light source having a different fluorescent characteristic.

9. The illumination apparatus according to claim 1, additionally comprising a further fluorescent light source, designed to output a further fluorescent light beam when excited by excitation radiation or a further excitation radiation by fluorescing.

10. The illumination apparatus according to claim 1, additionally comprising at least three further fluorescent light sources designed to output a further fluorescent light beam when excited by excitation radiation or at least a further excitation radiation by fluorescing.

11. The illumination apparatus according to claim 1, further comprising a primary light source which is designed to output the excitation radiation to excite the fluorescent light source.

12. The illumination apparatus according to claim 1, further comprising a control device, designed to provide a directing signal for directing the focusing light beam to the mirror mechanism and/or to provide an action signal for switching a light source on and off.

13. An analyzer for analyzing a sample in a microfluidic device, comprising:
a receiving region configured to receive the microfluidic device, and an illumination apparatus according to claim 1.

14. A method for illuminating a microfluidic device disposed in a receiving region of an analyzer, the method comprising:
outputting a fluorescent light beam in response to an excitation radiation;
converting the fluorescent light beam into a focused light beam; and
directing the focused light beam towards the microfluidic device.

15. The illumination apparatus according to claim 1, wherein the fluorescent light source is designed to output the fluorescent light beam in a narrow band with a spectral half-width less than 50 nm.

16. The illumination apparatus according to claim 1, wherein the fluorescent light source is designed to output the fluorescent light beam in a narrow band with a spectral half-width less than 30 nm.
